(19) United States
(12) Patent Application Publication
(10) Pub. No.: US 2003/0087456 A1
(43) Pub. Date: May 8, 2003

(54) Within-sample variance classification of samples

(76) Inventors: Howland D.T. Jones, Edgewood, NM (US); Craig M. Gardner, Arlington, MA (US); Edward L. Hull, Albuquerque, NM (US); Kristin A. Nixon, Albuquerque, NM (US); M. Ries Robinson, Albuquerque, NM (US)

Correspondence Address: V. Gerald Grafe, esq., General Counsel, InLight Solutions, Inc., 800 Bradbury SE, Albuquerque, NM, 87106, US

(21) Appl. No.: 10/262,692

(22) Filed: Oct. 2, 2002

Related U.S. Application Data
(60) Provisional application No. 60/328,000, filed on Oct. 8, 2001.

(51) Int. Cl. G01N 21/62

(52) U.S. Cl. 436/171; 436/164; 422/82.05; 422/82.09; 356/51; 356/300; 356/317; 702/19; 702/21

(57) ABSTRACT

An apparatus and method for infrared spectral analysis of samples to determine if the samples are normal or abnormal or to otherwise classify the sample. More specifically, the apparatus and method classify the sample on the basis of attenuation of infrared radiation at different wavelengths using a within-sample variance model. Further, the method and apparatus can include merging the output of multivariate classification models with the within-sample variance model applied to the infrared spectra sample such that their combined output results in a classification accuracy that is greater than any single model. The invention is useful in classifying, for example, biological samples such as human tissue, including cervical cells.

### CROSS REFERENCE

This application claims priority under 35 U.S.C §119 to U.S. Provisional Serial No. 60/328,000, entitled “Combining Multivariate Classification Models of Infrared Spectra of Biological Samples to Improve Accuracy”, filed Oct. 8, 2001, the disclosure of which is incorporated herein by reference.

### TECHNICAL FIELD

The present invention relates to spectral analysis of samples to determine if the samples are normal or abnormal or to otherwise classify the sample. More specifically, the present invention relates to classification of a biological sample on the basis of attenuation of infrared radiation at different wavelengths using a within-sample variance model.

### BACKGROUND

Infrared spectroscopy is sensitive to the rotational and vibrational energy levels of bonds, functional groups and molecules. The spectrum of a tissue sample thus contains information about the biochemical and morphological make-up of the sample. This information can be used to separate cells or tissues into classes according to some descriptive difference, such as cell type or disease status. Infrared spectroscopy offers the advantages of rapid, non-destructive, and automated testing using relatively inexpensive and robust equipment, all of which lead to cost-effective measurements.

Wong in U.S. Pat. No. 5,539,207, incorporated herein by reference, discloses a method of identifying tissue comprising the steps of determining the infrared spectrum of an entire tissue sample over a range of frequencies in at least one frequency band, and comparing the infrared spectrum of the sample with a library of stored infrared spectra of known infrared tissue types by visual comparison or using pattern recognition techniques to find the closest match. Thus, the infrared spectrum is compared with the library of stored data and from this comparison positive identification is made which can be applied to the detection of the tissue types and malignancies.

Haaland et al. in U.S. Pat. No. 5,596,992, incorporated herein by reference, disclose a multivariate classification technique applied to spectra from cell and tissue samples irradiated with infrared radiation to determine if the samples are normal or abnormal. Mid- and near-infrared radiation are disclosed as being used for in vitro and in vivo classifications using at least 3 different wavelengths. Haaland et al. teach that some normal/abnormal differences in cell and tissue samples are so subtle as to be undetectable using univariate analysis methods, but that accurate classification can be made using infrared spectroscopy and a multivariate calibration and classification method such as partial least squares, principal component regression, or linear discriminant analysis, comparing the spectrum of a sample with those from other samples.

Cohenford et al. in U.S. Pat. No. 6,146,897, incorporated herein by reference, disclose a method to identify cellular abnormalities which are associated with disease states. The method utilizes infrared spectra of cell samples which are dried on an infrared transparent matrix and scanned at the frequency range from 3000-950 cm⁻¹. The identification of samples is based on establishing a reference using a representative set of spectra of normal and/or diseased specimens. During the reference assembly process, multivariate techniques are utilized, comparing the spectrum of a sample with those from other samples.

When the information content that delineates the defined classes is large, a simple univariate measure such as the peak height of an absorbance band can be used for classification. When the changes are small, sophisticated multivariate techniques such as principal component analysis can combine the spectral values at many different wavelengths of light to provide classification ability. In either case, a classification model such as linear discriminant analysis is generated (or trained) from a set of spectral data taken from samples with known class assignments determined from an accurate, “gold standard” reference method. The goal of model generation is to seek some relationship (defined by the type of algorithm being used) between the spectral data and the known classes. This model is then used to predict the classes of new (test) samples. Comparing the classes predicted by the algorithm to the known classes provides estimates of the algorithm accuracy.

Current methods, however, have not demonstrated sufficient accuracy for many applications. Accordingly, there is a need for improved methods of classifying samples based on their optical characteristics.

### SUMMARY OF THE INVENTION

The present invention comprises systems and methods for classifying a sample utilizing spectral analysis. A “sample” refers to what is being classified, for example, a sample can comprise a group of cells from an individual, collected from one or more collection sites and at one or more collection times; a sample can comprise cells from a group of individuals (where the group is to be classified); a sample can comprise extracts from one or more fluids to be classified; a sample can comprise tissue measured in vivo. “Classifying samples” includes determination of any property of the sample, including, as examples, membership in one or more classes, analyte concentration in the sample, and presence or extent of a particular material or property. Variance in response to radiation within a single sample can allow classification of a sample. The variance is often discussed herein in terms of variance among regions of a sample, where a “region” refers to a distinguishable determination of the response to radiation. Examples of regions include different spatial portions of a sample, different times for determination of a response, and different preparation methods applied before determining a response (e.g., a single cell collection event, followed by preparation of subsets of the collected cells in different manners). The present invention contemplates a single treatment of within-sample variance, and the combination of multiple treatments of within-sample variance for classification. The present invention also contemplates combining classification models, for example, combining a within-sample variance classification with other classification methods.

A system according to the present invention can comprise means for generating light at a plurality of different wavelengths. The system can further comprise means for directing at least a portion of the generated light into a plurality of regions of a sample (e.g., cells in a biological sample). In an embodiment useful for classifying cervical cells, each region has an area of from about 100 μm² to about half the sample area. In a prepared slide, this would include from a fraction of a cell to many cells.

The system can further comprise means for collecting at least a portion of the infrared light after it has interacted with each region. Means for determining the intensity of the collected infrared light for each region are included, with the intensity determined as a function of the wavelength. The system can also comprise means for storing a within-sample variance classification model which contains data indicative of a correct classification of known sample variances. A processor means is coupled to the means for determining the measured intensities and the means for storing the model. The processor means determines the classification of the sample as one of two or more types by use of the within-sample variance classification model and the measured intensities for each region.

The stored classification model can be of various types related to the variance among the regions. One embodiment comprises a sample standard deviation model. Other embodiments comprise a sample mean absolute deviation model or a sample median absolute deviation model.

In methods according to the present invention, a biological sample comprising a plurality of cells can be provided. In some embodiments, the sample presents a substantially monocellular layer such as a sample prepared by the cytospin cell preparation technique or Cytyc Corporation's ThinPrep.

Infrared light at a plurality of different wavelengths is generated. The infrared light irradiates a plurality of regions of a biological sample and an optical characteristic of each region determined. An optical characteristic is a property of how the region interacts with incident radiation, for example absorption, reflection, scattering, transmission, Raman effects, optical path lengths, and combinations thereof. An optical characteristic determined at a plurality of different incident radiation properties (e.g., wavelengths) comprises a sample response spectrum. The optical characteristics of at least two of the plurality of regions can be used to classify the sample as one of two or more types, using a within-sample variance classification model. Examples of a within-sample variance classification model include a sample standard deviation model, a sample mean absolute deviation model, and a sample median absolute deviation model. Further, additional models can be applied to the spectral data to improve the accuracy of the classification.

### BRIEF DESCRIPTION OF THE DRAWINGS

FIG. 1 is a schematic diagram of an apparatus useful in conducting the classifications contemplated by this invention.

FIG. 2 is a flow chart of how samples were accepted into a study and how “gold standard” reference values were determined for those accepted samples.

FIG. 3 is a schematic of model building, model validation, and bundling.

FIG. 4 is an example of a Receiver Operating Characteristic Curve (ROC curve) generated from within-sample spectral standard deviation data (individual treatment) with an AUC of 0.74.

FIG. 5 is an AUC performance metric for each of the 229 individual model treatments generated from within-sample spectral standard deviation data.

FIG. 6 is an AUC performance metric plotted versus number of model treatments bundled (generated from within-sample spectral standard deviation data). The number of permutations shown for each data column is listed below the whiskers.

FIG. 7 is an example of a Receiver Operating Characteristic Curve (ROC curve) generated from within-sample spectral standard deviation data after 11 model treatments were bundled together. AUC=0.87.

FIG. 8 is an AUC performance metric for each of the 573 individual model treatments generated from within-sample spectral standard deviation data, within-sample spectral mean data and individual cell spectral data.

FIG. 9 is an example of a Receiver Operating Characteristic Curve (ROC curve) generated from within-sample spectral standard deviation data, within-sample spectral mean data and individual cell spectral data bundled together. AUC=0.91.

FIG. 10 is a MIR spectrum of a typical cervical cytology sample.

### DETAILED DESCRIPTION

The following detailed description should be read with reference to the drawings. The drawings, which are not necessarily to scale, depict illustrative embodiments and are not intended to limit the scope of the invention.

For the purposes of the application, the term “about” applies to all numeric values, whether or not explicitly indicated. The term “about” generally refers to a range of numbers that one of skill in the art would consider equivalent to the recited value (i.e., having the same function or result). In many instances, the terms “about” might include numbers that are rounded to the nearest significant figure.

As used in this specification and the appended claims, the singular forms “a”, “an”, and “the” include plural referents unless the context clearly dictates otherwise. Thus, for example, reference to a method of classifying “a biological sample” includes a method of classifying more than one biological sample regardless of source. As used in this specification and the appended claims, the term “or” is generally employed in its sense including “and/or” unless the context clearly dictates otherwise.

### EXAMPLE APPARATUS

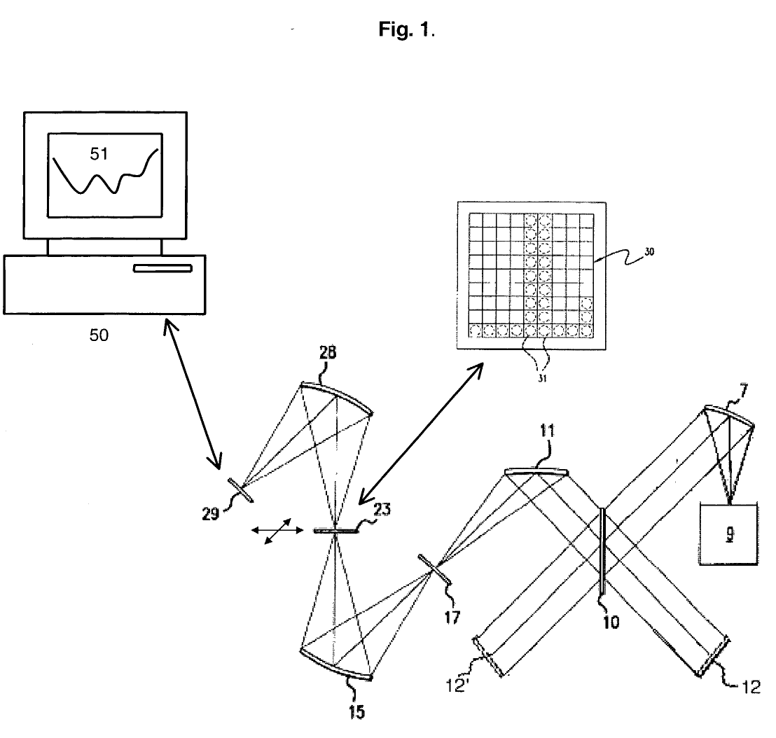

FIG. 1 is a schematic representation of an example apparatus according to the present invention. A radiation source (9) supplies radiation to a collimating mirror (7). The collimated beam travels to beamsplitter (10) which is the beamsplitter of a Michelson interferometer. The beam is split into two beams which travel to two end mirrors of the interferometer (12) and (12′). Mirror (12) is the fixed mirror and mirror (12′) is the moving mirror of the interferometer. The beams then return to beamsplitter (10) where they recombine and exit towards mirror (11). Mirror (11) focuses the beam onto aperture (17), the size of which is adjustable. The beam then travels to focusing mirror (15) which re-images aperture (17) onto the specimen (23). Specimen (23) is mounted on a moving stage so that it can move in a plane perpendicular to the beam axis. As specimen (23) is moved, the aperture is imaged onto different parts of the specimen (31). Plan view (30) is a representation of a specimen conceptually separated into different regions or portions. After the beam passes through a portion of the specimen, it continues to mirror (28). Mirror (28) refocuses the beam onto detector (29). The signal at the detector is processed by computer (50) and the resultant spectrum is stored on the hard disk and displayed on the monitor, (51). A spectrum is stored for each of the points (31) on the specimen to be mapped. The within-sample variance is calculated from this plurality of spectra. Other spectrographic analysis equipment or apparatus can be utilized. One system is disclosed in U.S. patent application Ser. No. 09/832,585 filed on May 11, 2001 and entitled “System for Non-Invasive Measurement of Glucose in Humans”, the disclosure of which is incorporated herein by reference. Other known infrared spectrographic devices can also be utilized, some of which are detailed in the examples below.

### WITHIN-SAMPLE VARIANCE CLASSIFICATION

A method for classifying a sample includes providing a sample that can be interrogated over a plurality of regions, for example, a sample comprising a plurality of cells spread over an area of a biological sample. The method can further include generating a plurality of different wavelengths of light and irradiating a plurality of regions of the sample with the plurality of different wavelengths. Intensity attenuations due to each region's interaction with the light can be measured to obtain a sample response spectrum comprising intensity information at multiple wavelengths for each of at least two of the plurality of regions. The sample can then be classified as one of two or more types from the measured intensity attenuations using a within-sample variance classification model.

The within-sample variance classification model provides a measure of variation or dispersion of a population of data values about a measure of central tendency. A measure of central tendency is any statistic that indicates in some sense a center of a population of data values. Examples of central tendency include, for example, the mean (the center of gravity of the population of data values), the median (a value for which half the population of data values is less than, and half is greater than), and the mode (the most common value of the data values).

If the population is centered by a measure of central tendency, i.e., a measure of central tendency is subtracted from each data value, then variation relates to a measure of central tendency of the magnitudes of those centered values. For example, the mean absolute deviation is the average of the absolute values of the data centered by the mean. Also, the median absolute deviation is the median of the absolute value of the data centered by the median. Finally, the statistic referred to as the variance is the mean value of the squares of the data centered by the mean of the data. There is also a distinction between population variance and sample variance. Population variance is as defined above for a population of data values. If a random sample of n data values (X₁, . . . Xₙ) is drawn from a large population, an average of the squares of the sampled data values centered by the sample average is the sample variance and is an estimator of the population variance. There are several variants of the sample variance:

$${S}^{2} = \frac{{\sum }_{i = 1}^{n} {( {X}_{i} - \overline{X} )}^{2}}{n + 1}$$

is the minimum mean squared error estimator of the population variance:

$${S}^{2} = \frac{{\sum }_{i = 1}^{n} {( {X}_{i} - \overline{X} )}^{2}}{n - 1}$$

is the unbiased estimator of the population variance; and

$${S}^{2} = \frac{{\sum }_{i = 1}^{n} {( {X}_{i} - \overline{X} )}^{2}}{n - 1} \frac{( N - n )}{( N - 1 )}$$

where the size of the population, N, is finite. The standard deviation is then given as the square root of a variance estimator, S.

For some samples, such as biological samples, Mid-infrared (MIR), Near-infrared (NIR), visible (VIS), and combinations thereof can be suitable. Mid-infrared (MIR) is generally defined as light wavelengths of 400-4,000 cm⁻¹. Near-infrared (NIR) is generally defined as light wavelengths of 4,000-14,000 cm⁻¹. Visible (VIS) is generally defined as light wavelengths of 14,000-33,333 cm⁻¹.

The number of regions of the sample can be selected to obtain a reliable estimate of variation based on statistics. Generally, more regions lead to more accurate determination of the variances. The number of regions can be from 2 to many. As an example, in a cervical cancer screening application, from 10 to 50 regions can be suitable. The area of each region can be large enough to obtain meaningful sample information; as an example, in classifying a sample comprising a plurality of cells, regions larger than one cell (e.g., an area large enough to include a plurality of cells) can be suitable. Each region can include a fraction of a cell to a number of cells conducive to obtaining a reliable estimate of variation based on statistics. When the number of cells to be measured is determined, the dimensions of the regions can be determined. As an example, for a cervical cancer screening application, the regions can have areas from about 100 μm² to about 150 mm².

The sample can be classified as one of two or more types based on the measured intensity attenuations. Table 1 shows some examples of classifications useful in some applications.

TABLE 1

| | |
|---|---|
| normal or abnormal | For cancer screening/diagnosis and |
| | process monitoring |
| normal, hyperplastic, dysplastic or | For cancer screening/diagnosis |
| neoplastic | |
| within normal limits, squamous intra- | For cervical cancer screening/ |
| epithelial lesion (high or low grade), | diagnosis |
| or carcinoma in-situ | |
| benign, pre-malignant, malignant | For cancer screening/diagnosis |
| Normal or In Need of Further Review | For cancer screening/diagnosis |
| male or female | For gender screening |
| hemolytic, lipemic or icteric | For serum samples |
| normal, prediabetic, or diabetic | For screening or diagnosis of |
| | diabetes |

### EXAMPLE OF WITHIN-SAMPLE VARIANCE CLASSIFICATION

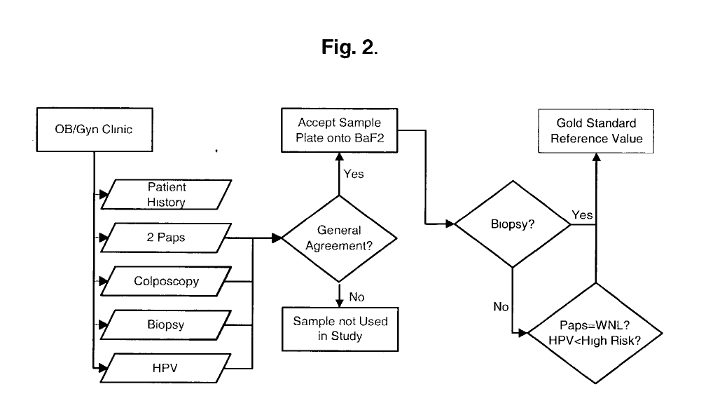

A within-sample variance classification according to the present invention was used to classify cervical samples as described below and depicted in the flow chart of FIG. 2.

Sample Collection. Cervical cell samples were collected from several women undergoing either routine gynecological examination or treatment for a cervical abnormality identified by a previous Pap smear. Cells were collected from the cervix using a cytobrush, which were then smeared onto a slide for a conventional Pap smear. Remaining cells on the cytobrush were immediately agitated from the brush and stored in a liquid preservative medium. These samples were collected from three different clinics. Due to the subjectivity and sometimes poor accuracy of the current Pap screening procedures, several reference measurements were acquired from these samples. These references included a conventional Pap smear, a ThinPrep pap reading, Colposcopy results (if available) and Biopsy results (if available). If there was general overall agreement between these reference measurements for a particular sample, then a Human Papiloma Virus (HPV) test was performed. HPV is believed to be the cause of cervical cancer and Digene Corporation provides a test that detects HPV and categorizes the strains of HPV detected as either high or low risk. A woman that provides a sample that has a high risk strain of HPV is more likely to develop cervical cancer than a woman that has no HPV or a low risk strain of HPV. If there was still general agreement between all references once we received the results from the HPV measurement, the sample was accepted into the study (FIG. 2). Fifty-six samples were accepted into this study.

Assignment of Class Reference Values. A majority of the samples accepted into the study had biopsy results, including half of the normal samples. For those samples that had a biopsy, the biopsy results were used as the “gold standard” reference for this study. For those normal samples that did not have biopsies, concordant Pap results and HPV (no HPV or low risk HPV) were used as the “gold standard reference” (FIG. 2). For this study, half of the samples were referenced as “normal” and half were referenced as “abnormal”. The “normal” samples were samples that were classified by the pathologist as “Within Normal Limits” (WNL). The “abnormal” samples were samples that were classified by the pathologist as “Squamous Intraepithelial Lesion” either as high grade (HSIL) or low grade (LSIL).

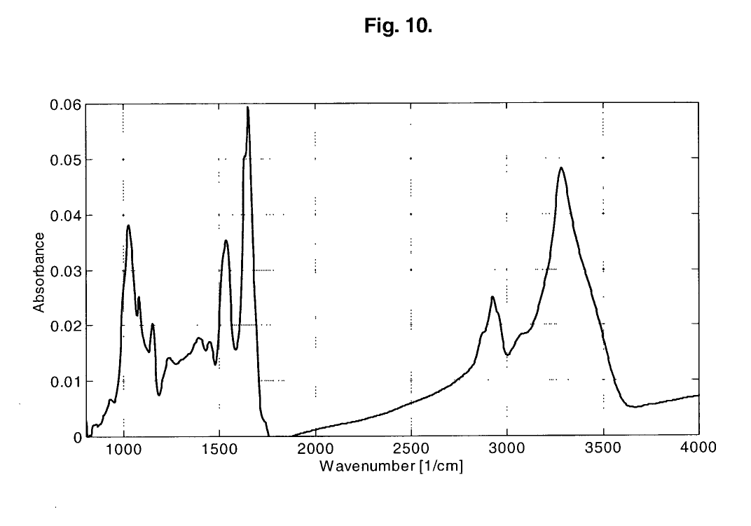

Spectral Collection. Each sample was plated onto a 20 mm diameter BaF₂ window using the ThinPrep methodology developed by Cytyc. Such samples can be dried, fixed, stained, coverslipped, or a combination thereof, and still be suitable for use with the present invention. Each sample was plated within 26 days of the placement of the sample in the liquid preservative medium. The ThinPrep methodology allowed us to acquire mid-infrared (MIR) transmission spectra from 30 randomly chosen individual unstained cells using a Nicolet Continuum infrared microscope coupled to a Nicolet Magna 550 Fourier Transform Spectrometer. Of the randomly chosen and collected cells for the study, only 4.3% of all cells (including all cells from both normal and abnormal samples) looked morphologically abnormal to the pathologist. The spectra were collected using a fixed aperture of 100 by 100 μm, the spectral resolution was 8 cm⁻¹, the collection time was 20 seconds per cell and the detector was a liquid cooled MCT. Immediately after each cell spectrum, a background spectrum was collected from a clear portion of the window. Following the collection of the unstained samples, the samples were stained using the standard Papanicolaou staining technique used for cervical cytology samples and spectra of stained cells were then collected in the same manner as the unstained samples. FIG. 10 shows a typical MIR cervical cell spectrum from the study.

Data Processing. The raw data were processed to absorbance spectra and collapsed from 30 cell spectra down to one standard deviation spectrum for each sample. This was accomplished by taking the standard deviation of the absorbance values across all 30 cell spectra for each wavelength. Other processing of the spectra, such as spectral region selection, linear baseline correction, normalization and area correction, occurred either before or after the standard deviation computation, provided the basis for some of the model treatments generated (Table 2). Principal component analysis (PCA) or partial least squares (PLS) were used to compress the spectral data before input into the model training and testing. Forty spectral loadings and 56×40 scores were generated from the entire spectral data set.

All of the above spectral pre-processing procedures are common and standard tools for those skilled in spectroscopy or chemometrics, except for the area correction methodology that we applied for this study. Because the microscope aperture was held fixed at 100×100 μm, a considerable amount of light that did not interact with the cell under interrogation was allowed to impinge upon the detector. The effect of this unabsorbed light, which is additive in transmittance space, introduces nonlinearities in the converted absorbance data. These nonlinearities are a source of variance in the spectral data that is not related to the sample itself.

In order to correct for these effects, a software system was created to analyze digital images of each of the cells taken at the time of spectroscopic data collection. This software system automatically calculated the area of the aperture (10,000 μm², typically) and the area of the cell. The true cellular absorbance spectrum can be calculated from these parameters by the following relationship:

$${A}_{true} ( λ ) = - {log}_{10} ( {T}_{true} ( λ ) ) = - {log}_{10} [ \frac{{T}_{cell} ( λ ) - f {T}_{bgd} ( λ )}{( 1 - f ) {T}_{bgd} ( λ )} ] ,$$

where Aₜᵣᵤₑ is the actual absorbance spectrum, Tₜᵣᵤₑ is the actual cellular transmission spectrum, T_{cell} is the measured cellular transmittance spectrum f is the fraction of the aperture area not occupied by the cell, and T_{bgd} is the measured background spectrum. Table 2 shows a summary of parameters varied to generate the model treatments. 4²×2⁴=256 model treatment permutations could be generated.

TABLE 2

| | |
|---|---|
| Spectral | Region (4) |
| Processing | 900-1750 cm⁻¹ |
| | 900-1300 cm⁻¹ |
| | 1300-1750 cm⁻¹ |
| | 900-1750 and 2700-3700 cm⁻¹ |
| | Linear baseline correction or not (2) |
| | Spectrum/band area normalization (4) |
| | Normalize to area (none, under a given band at 1150, or |
| | under a given band at 1305, unit area) |
| | Area Correction or not (2) |
| Data | Principal component analysis or Partial least squares (2) |
| Compression | Compute standard deviation to reduce to sample level (1) |
| Model | Linear discriminant analysis (1) |
| Algorithm | |
| Variable | Percent spectral variance explained or ratio of between- |
| Selection | class separation to within-class variance (2) |

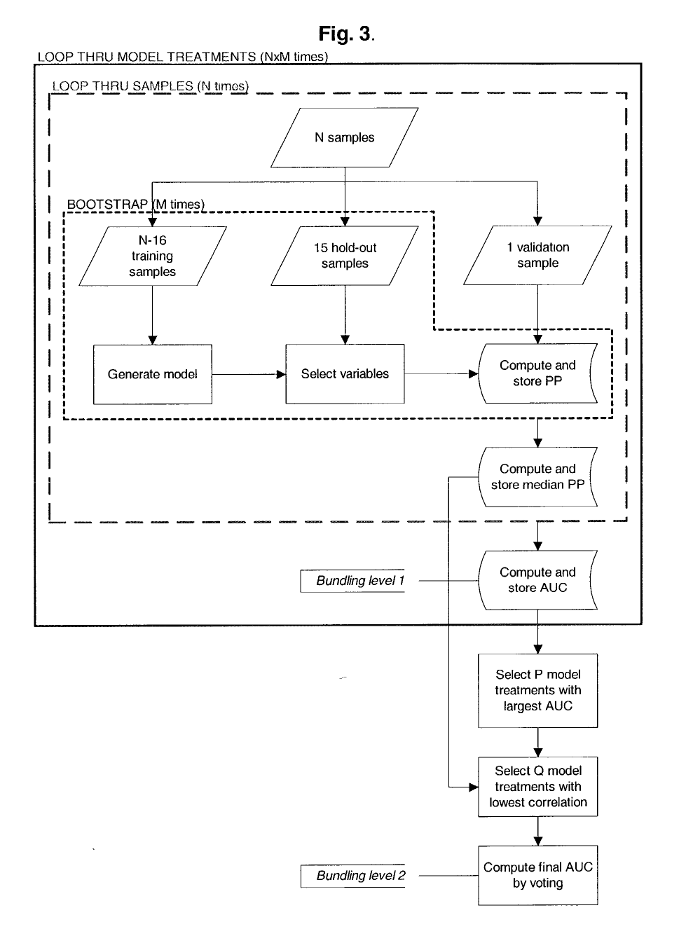

Model Building. The following sections on model building and validation are illustrated in FIG. 3 (up to bundling level 1). A linear discriminant analysis (LDA) classification algorithm was used to generate the various multivariate classification models. Other classification models can also be suitable, including, as examples, quadratic discriminant analysis (QDA), neural networks, unsupervised classification, classification and regression trees (CART), k-nearest neighbors, and combinations thereof. The explanatory (predictor) variables were the scores of the spectra, and the dependent variable (class) was the binary normal or abnormal reference value from each sample. The LDA algorithm assumes the distribution of variables within each class is multivariate normal; it estimates the within-class mean value of each variable, and the covariance matrix between the different variables of all training samples. This information is used to compute the distance in multidimensional variable space of each sample from the class means, which is in turn converted to a probability that the sample belongs to a given class. We coded the algorithm in Matlab and performed all data manipulation on Dell Dimension 1 GHz Pentium4 computers. Variations in the model-building step provided the basis for some of the model treatments generated. In addition, some models were trained by ordering the explanatory variables according to percent spectral variance explained, while other models used the ratio of between-class separation to within-class variance as the ranking method.

Model Validation. When predicting the class of a validation (test) sample, we used the scores generated from within-sample spectral standard deviation as the input to our linear discriminant classifier. The output of our classifier was the posterior probability (PP) that the sample belonged to the normal class. A sample's posterior probability is the classification model's estimate of the probability that the sample in question belongs to a given class. For example, a WNL PP of 0.9 means that there is a 90% probability that the sample belongs to the class of normal samples. The quantity 1-PP is therefore the probability that the sample belongs to the abnormal class. Due to the limited number of samples in our study, a bootstrapping algorithm was used to generate a set of 13 PPs for each of the 56 samples as follows (see FIG. 3). For each validation sample, a classification model was trained using data from 46 of the 55 remaining samples selected at random. This model was then used to generate PPs for the validation sample and the remaining 9 “hold-out samples.” This process was repeated 13 times for the same validation sample, with re-selection allowed in the training and hold-out sets. The 15×13=165 hold-out classification results were used to select the number of explanatory variables (spectral loadings) for the model treatment in question.

Results. Table 2 lists the elements varied to produce the different model treatments. We generated 229 out of the possible 256 model treatment permutations. Each model treats the data differently, for example by using different spectral regions before data compression, thus each model should be expected to give different performance values. We purposely chose individual treatments that were expected to give some classification ability, based on various reports in the literature.

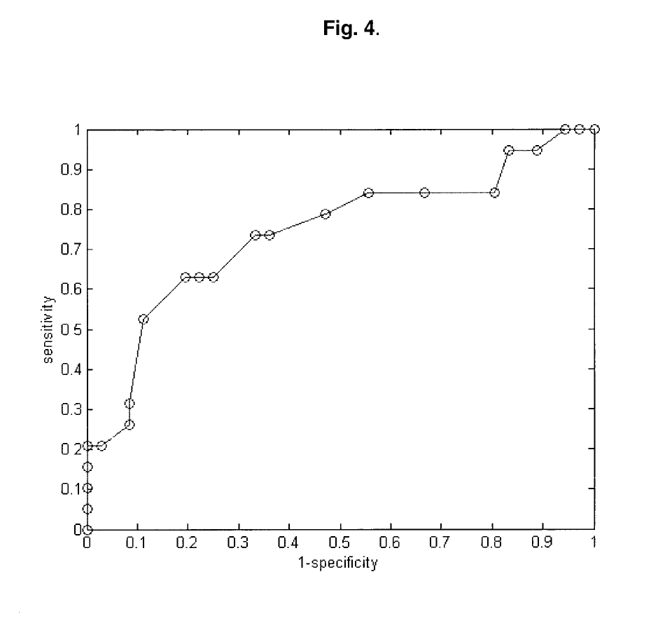

A performance metric (the area under the receiver operating characteristic curve; AUC) for each model treatment was computed. To compute the AUC for a given model treatment, a PP threshold for normal class membership was first established, and samples with a PP above this value were classified as normal. For example, if the threshold was set to 0.2 and the sample PP was 0.23 (23% probability of being normal), the sample's class as predicted by the model was normal. These 56 predicted classes were compared to the true classes, and the fractions of abnormal samples correctly classified (true positive rate) and normal samples misclassified (false positive rate) by the model were computed. These rates were computed as the PP threshold was varied from 0 to 1 in increments of 0.05. Continuing with the example, as the threshold was then changed to 0.3, the sample's predicted class switched to abnormal. These (true, false) positive rate pairs were plotted against each other to form a receiver operating characteristic curve. See, e.g., Swets, J A, “Measuring the accuracy of diagnostic systems,” Science 240,1285-1293,1988. The area under this curve (AUC) was used as a summary metric to judge the individual performance of each model treatment. AUCs of 0.5 and 1 specify no and perfect classification ability, respectively. FIG. 4 is an example of a Receiver Operating Characteristic Curve (ROC curve) generated from an individual model treatment, which has an AUC of 0.74.

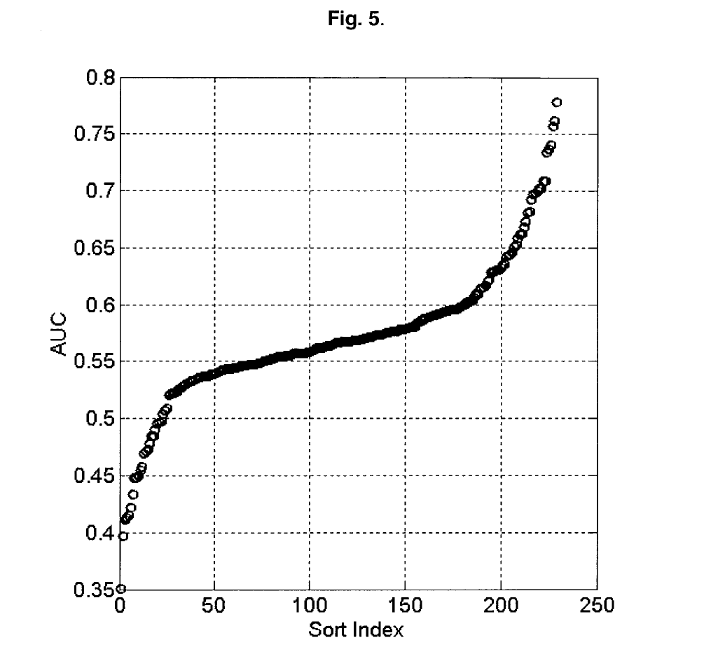

FIG. 5 shows the individual AUC performance metrics (computed using the median PP for each sample) for each model treatment. The AUCs vary from less than 0.5 (no classification ability) to 0.78. For comparison, the current screening method for cervical cancer (Pap smear followed by visual assessment of cells by a cytotechnologist and a pathologist) has been shown to have an AUC of 0.74±0.03. See, e.g., Fahey M T, Irwig L and Macaskill P, “Mta-analysis of Pap test accuracy,” Am. Jnl. Epid. 141(7), 680-689, 1995.

### EXAMPLE OF BUNDLING MULTIPLE WITHIN-SAMPLE VARIANCE TREATMENTS

Multiple model treatments can be used to improve classification accuracy over the previous example of using just a single model treatment. We have developed a method to merge multiple, multivariate classification models of infrared spectra of biological samples such that their combined output results in a classification accuracy that is greater than any single model. This approach, hereafter termed bundling, widens the acceptable use of infrared spectroscopy for classification of biological samples by providing improved performance levels.

Several reasons exist for bundling to improve accuracy. First, a classification model is trained using a finite amount of data. Because of this, there will be uncertainty in the model's predictive ability, leading to a decrease in the claimable model accuracy. For example, a test sample whose predicted value is close to the boundary that is used to determine class membership will have a high degree of uncertainty associated with its predicted class. Bundling models reduces this uncertainty. Bundling therefore can allow a higher percentage of samples from the entire population to be predicted with confidence. Second, a single classification model may provide acceptable accuracy for one subset (subset 1) of all possible samples, but may perform poorly for another subset (subset 2). Likewise, another model that emphasizes different spectral features or makes different assumptions about the distribution of classes may perform well on subset 2 but not on subset 1. Combining the outputs of these two models will therefore improve accuracy over the entire sample population.

To demonstrate this, similar steps (sample collection, assignment of class reference values, spectral collection, data processing, model building and model validation) were conducted as discussed above.

Bundling. Bundling the output of multiple models was performed at two levels as shown in FIG. 3). The first bundling level combined the 13 bootstrap results for each sample within each model treatment by simply taking the median PP of each sample. We then had 1 PP for each of the 56 samples and each treatment. A performance metric (the area under the receiver operating characteristic curve; AUC) for each model treatment was then computed, as it was used in the second level of bundling.

The second bundling level combined the median PP (calculated within each model treatment) for each sample across model treatments. The 17 models with the highest individual AUC performance metrics were chosen as candidates for bundling (see FIGS. 3 and 5). Up to 11 model treatments were bundled as follows. First, a PP data matrix was formed for the 56 samples (rows) and 17 candidate models (columns). The 17×17 correlation coefficient matrix of the PP matrix was computed, and the two models treatments with the smallest correlation between the PPs for each sample were chosen for bundling. These two model treatments were removed and the selection process was repeated 5 more times. This yielded from 2-12 model treatments to bundle; the remaining description illustrates the 11-treatment bundling case.

The performance of the 11 bundled models was evaluated using the AUC metric as well. For each PP threshold, majority voting among 11 PP values for each sample was used to specify the predicted class. For example, if the threshold was 0.2, and 6 or more of the PPs were greater than 0.2, the sample was classified as normal. As before, the PP threshold was swept from 0 to 1, predicted classes were compared to true classes, true and false positive rates were calculated, and the AUC metric was computed. Other combinations of models can also be used. For example, certain models can be accorded greater or lesser weight, perhaps dependent on their performance on certain types of samples, in a voting scheme. Some models can be combined arithmetically, e.g., mean or median, before combination with other models. Patterns in the outputs of the models can also be used to derive the classification. Each vote in a voting scheme can also be weighted by its probability or confidence level. The models can also be combined after evaluation against thresholds.

Results. Table 2 lists the elements varied to produce the different model treatments. We generated 229 out of the possible 256 model treatment permutations. Each model treats the data differently, for example by using different spectral regions before data compression, thus each model should be expected to give different performance values. We purposely chose individual treatments that were expected to give some classification ability, based on various reports in the literature.

While the first level of bundling operated on the same model treatment while varying just the training samples, the second level encompasses a much broader scope by bundling across model treatments. The 17 model treatments with the highest individual AUCs were chosen as candidates for bundling. This down selection process ensures that the bundling operation begins with data that is useful on its own. However, bundling models that have identical performance on each test sample would not change the accuracy, as all model results are perfectly correlated. We therefore down selected further by choosing model treatments whose performances were good, but not identical. We used the correlation coefficient between the 56-paired PP values for two models (without weight given to whether predictions were right or wrong) as a measure of how identical the models' performance were. We calculated all possible correlation coefficients amongst the 17-model treatments. We then selected the 6×(2 pairs) of model treatments that had the smallest correlations. In the final implementation, only the first eleven of these model treatments were used for bundling.

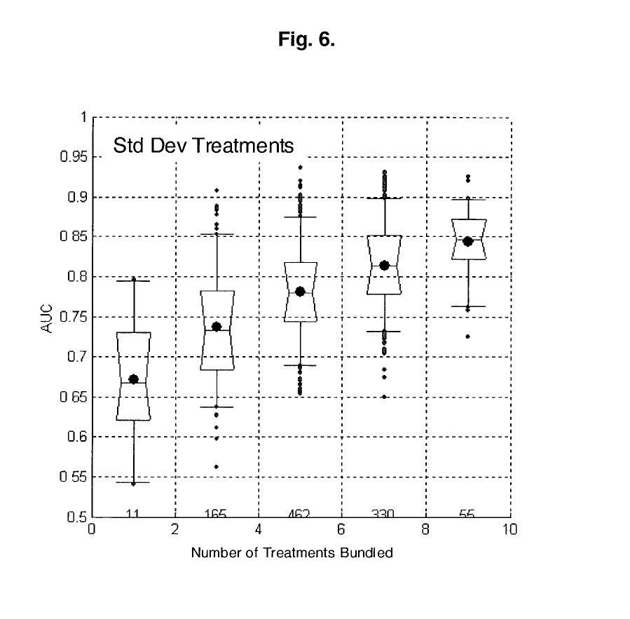

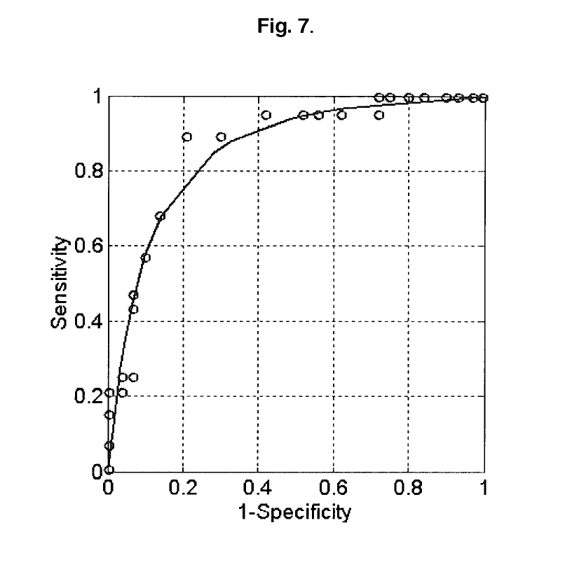

These 12 models were bundled in varying amounts using the voting method described above to compute bundled AUCs. As we wished to avoid ties in the voting process, we only used an odd number (3, 5, etc.) of models in the bundling process. FIG. 6 shows how the AUC improves with bundling across model treatments. The AUCs for a single model treatment (first level bundling) ranged from 0.54 to 0.79. For bundling 3 models, we choose 165 different combinations of 3 out of 12 possible models and computed the AUC for each. The 3-model bundling case yielded AUCs ranging from 0.56 to 0.91, a statistically significant improvement over the 11 individual model results. In fact, the bundled AUC continued to improve with number of models bundled. FIG. 7 illustrates the ROC curve generated after 11 models were bundled together. These results (AUC=0.87) gave significantly better results than the current screening method (0.74±0.03).

### EXAMPLE OF BUNDLING MULTIPLE WITHIN-SAMPLE VARIANCE TREATMENTS PLUS OTHER TREATMENTS

Within-sample variance classification can also be bundled with other methods. For example, models can be generated using within-sample mean spectra. These models can then be bundled together with the models generated from the within-sample variance (e.g., standard deviation) spectra to improve the classification accuracy over either method.

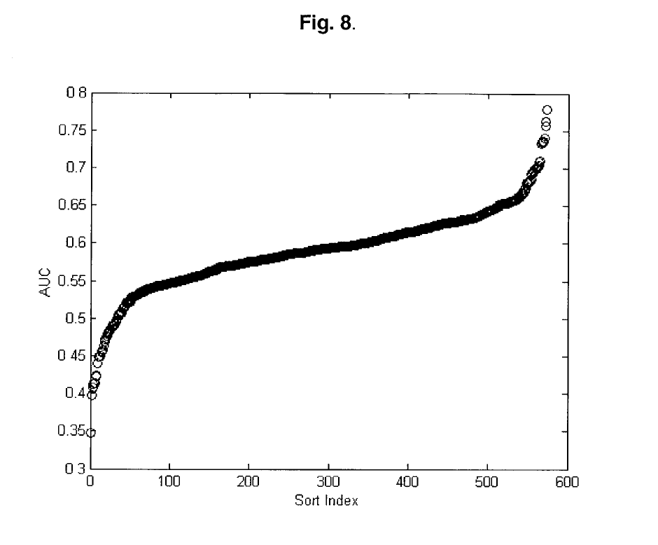

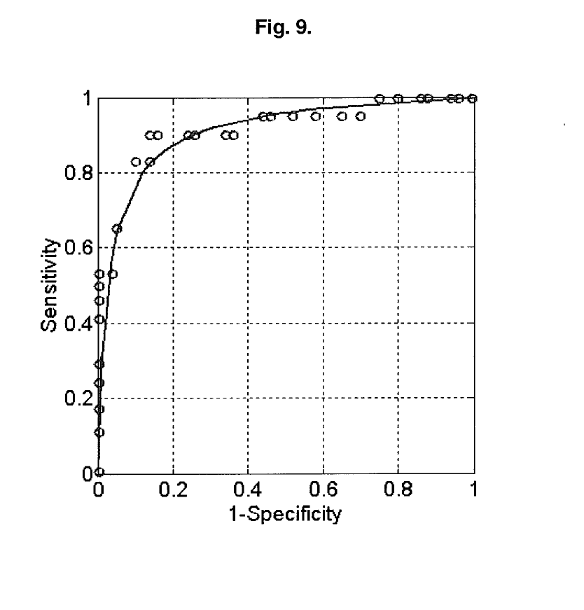

To demonstrate this, similar steps (sample collection, assignment of class reference values, spectral collection, data processing (see Table 3), model building, model validation and bundling) were conducted as discussed in the last example. Results were generated using cell-level spectra (unprocessed spectra), within-sample standard deviation spectra (as discussed before), and within-sample mean spectra (means of the cell-level spectra). FIG. 8 illustrates the individual AUC values for all 573 model treatments. The 14 model treatments with the highest individual AUCs were chosen as candidates for bundling. The ROC curve is plotted in FIG. 9 for the case of 11 treatments bundled, resulting in an AUC value of 0.91. In practice, though, it is likely that the test PP threshold would be fixed. At a fixed threshold, we compare sensitivity (fraction of abnormal samples detected) and specificity (fraction of normal samples detected) of our method to the current screening method. A 1999 government report stated that the current screening method has a sensitivity and specificity of 0.51 and 0.97 respectively. See, e.g., McCrory D C et al., “Evaluation of cervical cytology,” Agency for Health Policy and Research Evidence Report/Technology Assessment 5, 1999 (http://www.ahcpr.gov/clinic/cervsumm.htm). For a specificity of 0.97, our method using 9 bundled models yields a sensitivity of 0.6, again providing evidence that bundled multivariate classification models of infrared spectra provide improved accuracy. Table 3 shows a summary of parameters varied to generate the model treatments. 4²×3×2⁴=768 model treatment permutations could be generated.

TABLE 3

| | |
|---|---|
| Spectral | Region (4) |
| Processing | 900-1750 cm⁻¹ |
| | 900-1300 cm⁻¹ |
| | 1300-1750 cm⁻¹ |
| | 900-1750 and 2700-3700 cm⁻¹ |
| | Linear baseline correction or not (2) |
| | Spectrum/band area normalization (4) |
| | Normalize to area (none, under a given band at 1150, or |
| | under a given band at 1305, unit area) |
| | Area Correction or not (2) |
| Data | Principal component analysis or Partial least squares (2) |
| Compression | Compute standard deviation or mean to reduce to sample |
| | level, or leave data at the cell level (3) |
| Model | Linear discriminant analysis (1) |
| Algorithm | |
| Variable | Percent spectral variance explained or ratio of between- |
| Selection | class separation to within-class variance (2) |

New characteristics and advantages of the invention covered by this document have been set forth in the foregoing description. It will be understood, however, that this disclosure is, in many respects, only illustrative. Changes may be made in details, particularly in matters of shape, size, and arrangement of parts, without exceeding the scope of the invention. The scope of the invention is, of course, defined in the language in which the appended claims are expressed.

We claim:

1. A method of classifying a sample, comprising:
a. Determining an optical characteristic of the sample at a plurality of measurement events, wherein a measurement event is a determination of the optical characteristic of a spatial portion of the sample made at a time, and wherein at least one of the time and the spatial are different from the times and regions of other measurement events;
b. Evaluating a variance among the determined optical characteristics; and
c. Classifying the sample according to the variance.

2. A method of classifying a sample according to a within-sample variance classification model, comprising:
a. Determining a sample response spectrum for each of a plurality of regions of the sample;
b. Determining a variance among the sample response spectra; and
c. Classifying the sample according to the variance and the within-sample variance model.

3. A method as in claim 2, wherein determining a variance comprises determining the standard deviation, determining the median absolute deviation, determining the mean absolute deviation, determining the square of the standard deviation, or a combination thereof.

4. A method as in claim 2, wherein the within-sample variance model comprises a classification model based on a plurality of spectrum-reference pairs, wherein a spectrum-reference pair comprises a variance and a corresponding classification.

5. A method as in claim 4, wherein a spectrum-reference pair comprises a variance among a plurality of sample response spectra of a reference sample and a corresponding classification of the reference sample.

6. A method as in claim 2, wherein the within-sample variance model comprises a classification model based on LDA, QDA, neural network, unsupervised classification, CART, k-nearest neighbors, or a combination thereof.

7. A method as in claim 2, wherein the within-sample variance model comprises a classification model based on PCA or PLS scores of a plurality of spectrum-reference pairs, wherein a spectrum-reference pair comprises a variance and a corresponding classification.

8. A method as in claim 7, wherein the within-sample variance model comprises a classification model based on LDA, QDA, neural network, unsupervised classification, CART, k-nearest neighbors, or a combination thereof.

9. A method as in claim 2, wherein determining the sample response spectrum comprises:
a. Directing radiation to each of the plurality of regions;
b. Determining the interaction with the radiation of each region as a function of radiation characteristic.

10. A method as in claim 9, wherein the radiation characteristic comprises wavelength.

11. A method as in claim 9, wherein determining the interaction comprises determining the absorption of radiation, determining the elastic scattering of incident radiation, determining the inelastic scattering of incident radiation, determining the transmission of incident radiation, or a combination thereof.

12. A method of making a sample classification system, comprising:
a. Determining a plurality of spectrum-reference pairs, where each spectrum-reference pair comprises:
i. A variance among a plurality of sample response spectra; and
ii. A corresponding classification;
b. Establishing the sample classification system from a multivariate model based on the plurality of spectrum-reference pairs.

13. A method as in claim 12, wherein each sample response spectrum comprises an optical characteristic of a region of a sample, determined as a function of incident radiation wavelength.

14. A method as in claim 13, wherein the optical characteristic comprises absorption of radiation incident on the region, elastic scattering of radiation incident on the region, inelastic scattering of radiation incident on the region, transmission of radiation incident on the region, or a combination thereof.

15. A method as in claim 12, wherein the variance comprises the standard deviation, the median absolute deviation, the mean absolute deviation, the square of the standard deviation, or a combination thereof.

16. A method of classifying a sample according to a within-sample variance classification model, comprising:
a. Determining a sample response spectrum for each of a plurality of regions of the sample;
b. Determining a first variance metric among the sample response spectra;
c. Determining a second variance metric among the sample response spectra; and
d. Classifying the sample according to the first variance metric, the second variance metric, and the within-sample variance model.

17. A method as in claim 16, wherein determining a first variance metric comprises determining the standard deviation, determining the median absolute deviation, determining the mean absolute deviation, determining the square of the standard deviation, or combinations thereof.

18. A method as in claim 16, wherein the within-sample variance model comprises a classification model based on a plurality of spectrum-reference pairs, wherein a spectrum-reference pair comprises a first variance metric, a second variance metric, and a corresponding classification.

19. A method as in claim 16, wherein the within-sample variance model comprises a classification model based on PCA or PLS scores of a plurality of spectrum-reference pairs, wherein a spectrum-reference pair comprises a first variance metric, a second variance metric, and a corresponding classification.

20. A method as in claim 16, wherein determining the sample response spectrum comprises:
a. Directing radiation to the region;
b. Determining the interaction with the radiation of the region as a function of a radiation characteristic.

21. A method as in claim 20, wherein the radiation characteristic comprises wavelength.

22. A method as in claim 20, wherein determining the interaction comprises determining the interaction as a function of the wavenumber of radiation, for a plurality of wavenumbers from about 400 to about 14,000 cm⁻¹.

23. A method as in claim 20, wherein determining the interaction comprises determining the absorption of radiation, determining the elastic scattering of incident radiation, determining the inelastic scattering of incident radiation, determining the transmission of incident radiation, or a combination thereof.

24. A method according to claim 16, wherein the within-sample variance model comprises a combination of the first and second within-sample variance models, wherein:
a. the first within-sample variance model comprises a multivariate model based on the first variance metric determined for a plurality of references, each with a corresponding classification;
b. the second within-sample variance model comprises a multivariate model based on the second variance metric determined for a plurality of references, each with a corresponding classification.

25. A method according to claim 24, wherein the combination comprises a voting mechanism.

26. A method of classifying a sample according to a within-sample variance classification model, comprising:
a. Determining a sample response spectrum for each of a plurality of regions of the sample;
b. Determining a plurality of variance metrics among the sample response spectra;
c. Classifying the sample according to the plurality of variance metrics and the within-sample variance model.

27. A method as in claim 26, wherein determining a plurality of variance metrics comprises determining one or more of the standard deviation, the median absolute deviation, the mean absolute deviation, the square of the standard deviation, or a combination thereof.

28. A method as in claim 26, wherein the within-sample variance model comprises a classification model based on a plurality of spectrum-reference pairs, wherein a spectrum-reference pair comprises a plurality of variance metrics and a corresponding classification.

29. A method as in claim 26, wherein the within-sample variance model comprises a classification model based on PCA or PLS scores of a plurality of spectrum-reference pairs, wherein a spectrum-reference pair comprises a plurality of variance metrics and a corresponding classification.

30. A method as in claim 26, wherein determining the sample response spectrum comprises:
a. Directing radiation to the region;
b. Determining the interaction with the radiation of the region as a function of radiation characteristic.

31. A method as in claim 30, wherein the radiation characteristic comprises wavelength.

32. A method as in claim 30, wherein determining the interaction comprises determining the absorption of radiation, determining the elastic scattering of incident radiation, determining the inelastic scattering of incident radiation, determining the transmission of incident radiation, or a combination thereof.

33. A method according to claim 26, wherein the within-sample variance model comprises a combination of a plurality of within-sample variance models, wherein each of the plurality of within-sample variance models comprises a multivariate model based on one of the plurality of variance metrics determined for a plurality of references, each with a corresponding classification.

34. A method according to claim 33, wherein the combination comprises a voting mechanism.

35. A method of classifying a sample, comprising:
a. Determining a sample response spectrum for each of a plurality of regions of the sample;
b. Determining a variance among the sample response spectra;
c. Determining a variance classification of the sample according to the variance and the within-sample variance model;
d. Determining a second classification of the sample according to another classification method;
e. Classifying the sample according to a combination of the variance classification and the second classification.

36. A method as in claim 32, wherein the second classification method comprises a mean spectrum classification method.

37. A method as in claim 32, wherein determining a variance comprises determining the standard deviation, determining the median absolute deviation, determining the mean absolute deviation, determining the square of the standard deviation, or a combination thereof.

38. A method as in claim 32, wherein the within-sample variance model comprises a classification model based on a plurality of spectrum-reference pairs, wherein a spectrum-reference pair comprises a variance and a corresponding classification.

39. A method as in claim 32, wherein a spectrum-reference pair comprises a variance among a plurality of sample response spectra of a reference sample and a corresponding classification of the reference sample.

40. A method as in claim 32, wherein the within-sample variance model comprises a classification model based on PCA or PLS scores of a plurality of spectrum-reference pairs, wherein a spectrum-reference pair comprises a variance and a corresponding classification.

41. A method as in claim 32, wherein determining the sample response spectrum comprises:
a. Directing radiation to each of the plurality of regions;
b. Determining the interaction with the radiation of each region as a function of radiation characteristic.

42. A method as in claim 41, wherein the radiation characteristic comprises wavelength.

43. A method as in claim 41, wherein determining the interaction comprises determining the absorption of radiation, determining the scattering of incident radiation, determining the transmission of incident radiation, or a combination thereof.

44. An apparatus for classifying a sample, comprising:
a. A source of radiation;
b. Means for directing the radiation to each of a plurality of regions of the sample;
c. Means for detecting the interaction of each of the plurality of regions with the radiation;
d. Means for determining a variance among the regions' interactions;
e. A multivariate model that classifies the sample based on the determined variance.

45. A method as in claim 1, wherein the sample comprises a biological sample.

46. A method as in claim 2, wherein the sample comprises a biological sample.

47. A method as in claim 12, wherein the sample comprises a biological sample.

48. A method as in claim 16, wherein the sample comprises a biological sample.

49. A method as in claim 26, wherein the sample comprises a biological sample.

50. A method as in claim 35, wherein the sample comprises a biological sample.

51. An apparatus as in claim 44, wherein the sample comprises a biological sample.

52. A method as in claim 1, wherein the sample comprises a cervical cell sample.

53. A method as in claim 2, wherein the sample comprises a cervical cell sample.

54. A method as in claim 12, wherein the sample comprises a cervical cell sample.

55. A method as in claim 16, wherein the sample comprises a cervical cell sample.

56. A method as in claim 26, wherein the sample comprises a cervical cell sample.

57. A method as in claim 35, wherein the sample comprises a cervical cell sample.

58. An apparatus as in claim 44, wherein the sample comprises a cervical cell sample.

59. A method as in claim 1, wherein the sample comprises a cervical cell sample deposited in a substantially monolayer.

60. A method as in claim 2, wherein the sample comprises a cervical cell sample deposited in a substantially monolayer.

61. A method as in claim 12, wherein the sample comprises a cervical cell sample deposited in a substantially monolayer.

62. A method as in claim 16, wherein the sample comprises a cervical cell sample deposited in a substantially monolayer.

63. A method as in claim 26, wherein the sample comprises a cervical cell sample deposited in a substantially monolayer.

64. A method as in claim 35, wherein the sample comprises a cervical cell sample deposited in a substantially monolayer.

65. An apparatus as in claim 44, wherein the sample comprises a cervical cell sample deposited in a substantially monolayer.

66. A method as in claim 1, wherein the sample comprises a cervical cell sample deposited on a slide that is substantially transparent to both IR and visible light, stained, and coverslipped.

67. A method as in claim 2, wherein the sample comprises a cervical cell sample deposited on a slide that is substantially transparent to both IR and visible light, stained, and coverslipped.

68. A method as in claim 12, wherein the sample comprises a cervical cell sample deposited on a slide that is substantially transparent to both IR and visible light, stained, and coverslipped.

69. A method as in claim 16, wherein the sample comprises a cervical cell sample deposited on a slide that is substantially transparent to both IR and visible light, stained, and coverslipped.

70. A method as in claim 26, wherein the sample comprises a cervical cell sample deposited on a slide that is substantially transparent to both IR and visible light, stained, and coverslipped.

71. A method as in claim 35, wherein the sample comprises a cervical cell sample deposited on a slide that is substantially transparent to both IR and visible light, stained, and coverslipped.

72. An apparatus as in claim 44, wherein the sample comprises a cervical cell sample deposited on a slide that is substantially transparent to both IR and visible light, stained, and coverslipped.

73. A method of classifying a sample, comprising:
a. Determining a sample response spectrum of the sample;
b. Determining a first classification of the sample according to a first multivariate classification method;
c. Determining a second classification of the sample according to a second multivariate classification method;
d. Classifying the sample according to a combination of the first classification and the second classification.
